(19) United States
(12) Patent Application Publication
(10) Pub. No.: US 2008/0072826 A1
(43) Pub. Date: Mar. 27, 2008

(54) Teat rubber for two-chamber milking cups

(76) Inventor: Fritz Happel, Baisweil (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/517,191

(22) Filed: Sep. 6, 2006

(51) Int. Cl. A01J 5/04

(52) U.S. Cl. 119/14.49

(57) ABSTRACT

A teat rubber for two-chamber milking cups is described in which the longitudinal stiffness of the teat rubber wall in the massage region associated with the teat is substantially higher than the stiffness of the teat rubber in the radially inwardly directed folding direction.

### FIELD

The present disclosure relates to a teat rubber for two-chamber milking cups in which the teat rubber clamped at both ends is periodically exposed to a pressure difference between the teat rubber inner space and the intermediate space present between the teat rubber and the milking cup.

### BACKGROUND

The massage effect of the teat rubbers exerted on the teats in two-space milking cups is based on the changes in pressure difference between the teat rubber inner space and the intermediate space between the teat rubber and the milking cup which result in a periodic collapsing of the teat rubber.

There is an endeavor today to milk with a vacuum which is as low as possible since the harmful effect of the vacuum on the teat is generally known. A lowering of the milking vacuum, however, necessarily has the result that a reduction of the pressure difference used for the teat massage also takes place and the massage effect is thereby impaired.

To nevertheless be able to use the lower pressure difference practically for the massage, it is known to reduce the fold-in resistance of the teat rubber in that the teat rubber is made with thinner walls. The thin wall design of the teat rubber, however, has the disadvantage that this thin-wall teat rubber nestles against the lower part of the teat under the effective pressure difference in the massaging cycle without effectively massaging It. The desired reduction in the vacuum operative at the teat is thus purchased with an unwanted impairment of the massaging of the teat during the massager cycle.

### SUMMARY

It is the object of the present disclosure to design a teat rubber such that a good massage of the teat is in particular ensured even at a low vacuum and with the reduction of the usable pressure difference associated therewith.

This object is substantially satisfied in accordance with the present disclosure in that the longitudinal stiffness of the teat rubber wall in the massage region associated with the teat is substantially higher than the stiffness of the teat rubber in the radially inwardly directed folding direction.

It is possible with a teat rubber designed in this manner to utilize the largest pressure difference present beneath the teat to transfer the pronounced collapse of the teat rubber resulting in this region due to the selected stiffness ratios to the teat extremely effectively due to the pressure shift achieved and to ensure a good massage of the teat.

A plurality of massage strips is preferably provided which in particular extend approximately from the region of the upper clamping of the teat rubber in the longitudinal direction up to at least half the clamp-in length and preferably beyond it, are provided by thick-wall regions and adjoin thin-wall regions in each case at least in the peripheral direction of the teat rubber, whereby the desired low fold-in resistance can be preset.

It becomes possible by this design to ensure a particularly effective transfer of massage forces controlled by pressure difference onto the teat at a very low fold-in resistance. The massage surfaces or massage strips formed by thickened portions of the teat rubber wall, in particular outwardly occurring thickened portions of the teat rubber wall, can generally extend axially up to the two clamp-in ends of the teat rubbers in the milk cup liner; however, these massage regions are preferably guided only from the upper clamp-in position up to half the clamp-in length or somewhat beyond it, i.e. up to and into the region of the lower third. The massage surfaces preferably have longitudinal furrows or longitudinal grooves which approximately correspond in depth to the thickness of the thin-wall surfaces provided for folding. These measures together result in an extremely low fold-in resistance.

Viewed in cross-section, two of these massage surfaces are preferably oppositely located, flanked on both sides by thin-wall surfaces which effect the desired extremely low fold-in pressure. In this design, the fold-in direction parallel to the massage surfaces must be ensured. This can take place in that the teat rubber is made oval In cross-section with its largest length parallel to the massage surfaces. A further possibility consists of the back of the massage surfaces practically contacting the inner wall of the milk cup liner so that an erroneous collapsing is prevented.

No fixing of the fold-in direction is only required for the case that the teat rubber is fitted all round with massage surfaces which have longitudinal furrows or longitudinal grooves.

In accordance with a further advantageous aspect of the teat rubber in accordance with the present disclosure, this teat rubber is divided into an upper massage part facing the teat rubber head and having the already described massage surfaces and a lower part made with a thin wall to achieve a closing off of the inner space from the permanent vacuum. The wall thickness is selected to be so low that a lateral loop formation results on the collapse of this lower teat hose part which is as tight as possible and which, in dependence on the wall thickness, only permits a restricted passage of vacuum to the teat rubber inner space in the massage cycle.

A relief from vacuum can thus already be achieved in the direction of atmospheric pressure in the inner space at a low milk flow of, for example, 0.5 l/min. The massage surfaces should also extend at least up to the middle of the fold-in length, and preferably somewhat beyond it, up to and into the region of the lower third, in this case to ensure the already described lifting force to achieve a good teat massage.

If a relief from vacuum in the inner space disposed beneath the teat should be achieved even without milk flow, known close-off aids, e.g. a spreading piece in accordance with DE-A-1 296 807, can be used.

In a particularly advantageous embodiment, the inner space of the teat rubber in accordance with the present disclosure is aerated with atmosphere in a known manner via a nozzle. This can take place both from the teat rubber head and from the lower clamp-in position.

Further advantageous features and aspects of the present disclosure are set forth In the dependent claims and will also be explained in the following.

Further areas of applicability of the present disclosure will become apparent from the detailed description provided hereinafter. It should be understood that the detailed description and specific examples, while indicating the preferred embodiment of the present disclosure, are intended for purposes of illustration only and are not intended to limit the scope of the present disclosure.

### BRIEF DESCRIPTION OF THE DRAWINGS

The present disclosure will become More fully understood from the detailed description and the accompanying drawings, wherein:

FIG. 1 is a schematic longitudinal sectional representation of a teat rubber in accordance with an embodiment of the present disclosure clamped in a milking cup;

FIG. 2 is a sectional representation along the line C-D of FIG. 1; and

FIG. 3 is a sectional representation in accordance with the line A-B in FIG. 1.

### DETAILED DESCRIPTION

The following description of the preferred embodiment is merely exemplary in nature and is in no way intended to limit the present disclosure, its application, or uses.

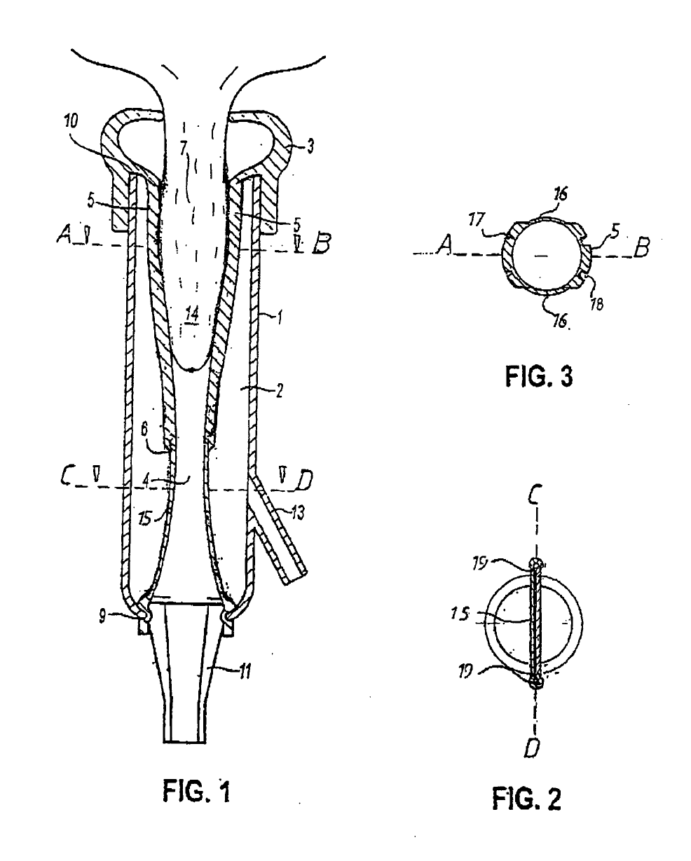

In accordance with FIG. 1, a teat is introduced through the teat rubber head 3 into the teat rubber designed in accordance with an embodiment variant of the present disclosure and is disposed, including the lower teat part 14, between the massage surfaces 5 whose fold-in resistance is preferably reduced by the longitudinal furrows 17 or longitudinal grooves 18. The largest pressure difference arises beneath the teat tip between the inner space 4 and the intermediate space 2.

At the start of the massage cycle, i.e. when the intermediate. space 2 is connected to atmosphere via the port 13, the teat rubber starts to collapse due to the pressure difference to the vacuum in the inner space 4.

The reinforced massage surfaces 5 extend in this example from the region of the upper clamping up to the point 6 which is disposed well beneath half the clamp-in length of the teat rubber. The side thin-wall region 16, which preferably extends approximately beyond the clamp-in length of the teat rubber in its different aspects, serves for the achieving of an extremely flow fold-in resistance. The lower thin-wall hose part 15 serves the closing off of the inner space 4 from the vacuum, as shown in section C-D in FIG. 2.

The thickness of the thin-wall region 16 and the thickness of the wall of the hose part 15 can be different.

It is clear that the region of the largest pressure difference between the inner space 4 and the intermediate space 2 is utilized due to the reinforced massage surfaces, their design and their longitudinal extent the massage surfaces having only a low flexibility transverse to their longitudinal extent act in the manner of a lever supported close to the teat at one end and being maximally moved out at the other end by the largest pressure difference, whereby pronounced massage forces are exerted onto the respective teat by the lever transmission.

FIG. 3 shows the section A-B from which the design of the thin-wall surface 16 and of the massage surfaces 5 with the longitudinal furrows 17 or longitudinal grooves 18 can be seen. The latter are to be understood as folding aids. The depth of these furrows or grooves is selected such that the remaining wall thickness at the base with respect to the furrows or grooves approximately corresponds to the thickness of the thin-wall surface 16.

This longitudinal sectioning of the massage surfaces together with the thin-wall surface 16 results in an extremely low fold-in resistance. The shaping of the longitudinal furrow 17 or longitudinal grooves 18 can advantageously take place such that, on the massage, i.e. when the massage surfaces contact the teat 14 due to the pressure difference and the utilized lever effect, a practically closed massage surface is present, i.e. the longitudinal furrows 17 or longitudinal grooves 18 are closed and their side surfaces contact one another.

The already mentioned FIG. 2 shows the situation of the closing off of the thin-wall hose part 15 in the lower region of the teat rubber in section. Due to the loop formation due to pressure difference in the region at the end side, connection passages 19 to the inner space 4 are created in the massage cycle whose free cross-sections can be preset by selection of the thickness of the hose part 15. The thickness of the hose part 15 can be selected independently of the thin wall 16 at the teat side.

The description of the present disclosure is merely exemplary in nature and, thus, variations that do not depart from the gist of the present disclosure are intended to be within the scope of the present disclosure. Such variations are not to be regarded as a departure from the spirit and scope of the present disclosure.

### REFERENCE NUMBER LIST

1 milk cup liner
2 intermediate space
3 teat rubber head
4 innerspace
5 massage surface
6 length of the massage surface
7 teat
9 lower clamping
10 upper clamping
11 inspection glass
13 port
15 lower thin wall
16 lateral thin wall
17 longitudinal furrow in the massage surface
18 longitudinal groove in the massage surface
19 close-off openings

What is claimed is:

1. A teat rubber for two-chamber milking cups in which the teat rubber clamped at both ends is periodically exposed to a pressure difference between the teat rubber inner space and the intermediate space present between the teat rubber and the milking cup, wherein the longitudinal stiffness of the teat rubber wall in the massage region associated with the teat is substantially higher than the stiffness of the teat rubber in the radially inwardly directed folding direction.

2. A teat rubber in accordance with claim 1, wherein a plurality of massage strips is provided which extend in particular approximately from the region of the upper clamping of the teat rubber in the longitudinal direction up to at least half the clamp-in length, are formed by thick-wall regions and adjoin thin-wall regions in each case at least in the peripheral direction of the teat rubber.

3. A teat rubber in accordance with claim 1, wherein the strip-shaped or areally made massage strips are arranged mutually diametrically opposite in each case, with the thin-wall regions adjoining the massage strips and/or surrounding them having a wall thickness corresponding to a fraction of the wall thickness of the massage strips.

4. A teat rubber in accordance with claim 1, wherein two mutually diametrically opposed areal massage regions having an increased wall thickness are provided, with these massage regions being connected to one another via thin-wall regions and with grooves or furrows extending in the longitudinal direction dividing the thick-wall regions into a plurality of massage strips.

5. A teat rubber in accordance with claim 4, wherein the thickness of the teat wall in the region of the groove or furrow base disposed between the massage strips is approximately equal to the thickness of thin-wall regions.

6. A teat rubber in accordance with claim 4, wherein the thin-wall surfaces ensuring the fold-in movement preferably have a thickness of 1 to 1.5 mm and the massage regions preferably have a thickness of approximately 2.5 to 3 mm with a teat rubber material of 55 Shore.

7. A teat rubber in accordance with claim 1, wherein the teat rubber has an oval cross-section at least in a part region of its length, with the massage surfaces being associated with the long wall sections.

8. A teat rubber in accordance with claim 1, wherein the back of the massage surfaces practically contacts the inner wall of the milking cup for the presetting of a defined fold-in direction.

9. A teat rubber in accordance with claim 1, wherein a region of the teat rubber disposed beneath the massage surfaces is made as a thin-wall region whose wall thickness can be preset independently of the wall thickness of the thin-wall regions cooperating with the massage surfaces.

10. A teat rubber in accordance with claim 1, wherein longitudinal grooves or longitudinal furrows dividing the massage surfaces in the massage strip regions are dimensioned and shaped such that the grooves or furrows are closed in the fold-in state and a stable massage surface is formed in this process.

11. A teat rubber In accordance with claim 1, wherein the massage surfaces or massage strips consist of radially outwardly thickened teat rubber regions.
